(19) United States
(12) Patent Application Publication
(10) Pub. No.: US 2025/0206110 A1
(43) Pub. Date: Jun. 26, 2025

(54) CONVERTIBLE TOP HAVING COUPLED MULTI-BAR ARRANGEMENTS

(71) Applicant: Webasto SE, Stockdorf (DE)

(72) Inventors: Cedric LANGLAIS, Stockdorf (DE); Alexander HAIMERL, Stockdorf (DE)

(21) Appl. No.: 18/971,473

(22) Filed: Dec. 6, 2024

(30) Foreign Application Priority Data
Dec. 22, 2023 (DE) 10 2023 136 565.7
Feb. 6, 2024 (DE) 10 2024 103 222.7

(51) Int. Cl. B60J 7/12

(52) U.S. Cl. CPC B60J 7/1265

(57) ABSTRACT

A convertible top having a first and second curved roof shell, and a convertible top linkage, by which the two roof shells are displaceable between a cover position, which spans a vehicle interior and in which two roof shells are disposed one behind the other in the longitudinal roof direction, and a storage position, which opens the vehicle interior towards the top and in which the two roof shells are received by a convertible top storage space and disposed one behind the other in an upright position in the same curve direction. The convertible top a link arrangement on each side in relation to a vertical longitudinal center convertible-top plane, the link arrangements each having a first multi-bar arrangement, a second multi-bar arrangement, which is driven by the first multi-bar arrangement, and a main bearing, on which the first multi-bar arrangement is articulated and adjustable in height.

### CROSS-REFERENCE TO RELATED APPLICATION(S)

This application claims the benefit of German patent application No. 10 2023 136 565.7, filed Dec. 22, 2023, and German patent application No. 10 2024 103 222.7, filed Feb. 6, 2024, which are both incorporated herein by reference in their entirety.

### TECHNICAL FIELD

A convertible top comprising two roof shells displaceable between a convertible top position spanning a vehicle interior and a storage position releasing the vehicle interior towards the top.

### BACKGROUND

A convertible top which is formed as a retractable hard top or as a convertible roof and which is part of a convertible vehicle is known from document DE 102 94 214 B4, for example. The convertible top forms a displaceable vehicle roof, which comprises rigid roof shells and a convertible top linkage. By means of the convertible top linkage, the rigid roof shells, which form a convertible top cover, can be displaced between a convertible top position which spans the vehicle interior and in which the roof shells are disposed flush one behind the other in the longitudinal roof direction and a storage position which releases the vehicle interior towards the top and in which the roof shells are received in a convertible top storage space, which is disposed to the rear of a vehicle interior. The convertible top linkage comprises a link arrangement on each of two sides of a vertical longitudinal center plane of the top, said link arrangement having a main link arrangement which comprises two main links which form a multi-bar linkage and which are pivotably disposed on a main bearing fixed to the body of the vehicle. A drive unit for the main link arrangement is disposed in the area of the main bearing. In the storage position, the roof shells are disposed essentially horizontally one above the other in the top storage area. For this purpose, the storage area must be designed in such a manner that it offers sufficient space in the longitudinal vehicle direction.

### SUMMARY

The object of the invention is to create a convertible top of the make mentioned above for which a convertible top storage space having small dimensions in the longitudinal vehicle direction is sufficient.

This object is attained by the convertible top having the features of claim 1.

According to the invention, a convertible top is thus proposed which comprises a first curved roof shell, a second curved roof shell and a convertible top linkage, by means of which the two roof shells are displaceable between a cover position, which spans a vehicle interior and in which the two roof shells are disposed one behind the other in the longitudinal roof direction so as to be flush with each other, and a storage position, which opens the vehicle interior towards the top and in which the two roof shells are received by a convertible top storage space and are disposed one behind the other in an upright position in the same curve direction. The convertible top linkage comprises a link arrangement on each of two sides in relation to a vertical longitudinal center convertible-top plane, the link arrangements each comprising a first multi-bar arrangement, a second multi-bar arrangement, which is driven by the first multi-bar arrangement, and a main bearing, on which the first multi-bar arrangement is articulated and which is adjustable in height.

The design of the convertible top according to the invention makes it possible for the roof shells to be disposed such in the storage space in the storage position that only a small amount of space is required in the longitudinal vehicle direction. In the upright position, the edges of the roof shells, which point in the direction of the vehicle front in the convertible top position, point upwards. The roof shells are each pivoted by approximately 70° to 110° compared to the convertible top position.

Owing to the height adjustment of the main bearing and the resulting ability to lower the roof shells and the convertible top linkage, the convertible top can be lowered far into the vehicle body to induce the storage position.

In a special embodiment of the convertible top according to the invention, the adjustment from the convertible top position to the storage position takes place in such a manner that the two roof shells are initially adjusted to an upright position in which they are disposed one behind the other in an interlocking manner. The first roof shell preferably forms the roof shell which is disposed on the front side in the convertible top position in relation to the vehicle orientation and, in particular, is fixed to a front header of the vehicle in question. The second roof shell is disposed to the rear of the first roof shell, the outer sides of the two roof shells preferably merging flush with one another. In the upright or essentially vertical alignment, which is present in the storage position, the first roof shell is preferably also located to the front of the second roof shell. This arrangement means that the forces required for adjustment can be kept to a minimum. Due to the vertical arrangement of the roof shells in the storage position, installation space in the longitudinal vehicle direction can be used for other vehicle elements, such as the vehicle engine. The movement path of the two roof shells during the opening process can be kept short, as the first roof shell does not have to be moved backwards over the second roof shell. Furthermore, the speed of movement can be kept low, as the short adjustment paths mean that short cycle times can still be achieved during the opening and closing process. When the convertible top is adjusted to the convertible top position, the front roof shell therefore meets the front header of the vehicle in question at low speed. This reduces the risk of so-called header slamming problems.

The convertible top according to the invention forms a so-called RHT (retractable hard top) and/or a folding roof, which is provided with rigid roof shells, each of which is provided with a curvature and/or crowning defining the shape of the roof.

In a constructively advantageous embodiment of the convertible top according to the invention, the first multi-bar arrangement is a four-bar arrangement and a link of the four-bar arrangement is a bearing link, to which the second roof shell is connected and which is preferably a main link, which is pivotably mounted on the main bearing. The movement of the second roof shell relative to the main bearing when adjusting the convertible top between the convertible top position and the storage position is then a simple pivoting movement about the pivot axis, which is defined by the articulation point of this main link to the main bearing.

In another special embodiment of the convertible top according to the invention, a drive motor is fastened to the bearing link for the four-bar arrangement. In this case, the drive motor is pivoted together with the bearing link when the convertible top linkage is adjusted. The drive motor is therefore a component of the bearing link. Another link of the four-bar linkage can be connected directly to a drive shaft or a drive gear of the drive motor driven by the drive shaft. The drive shaft and/or the drive gear thus forms a further articulation point of the four-bar linkage.

In an alternative embodiment of the convertible top according to the invention, however, the drive motor can also be fastened to the main bearing or one of the other two links of the four-bar linkage.

In order to be able to drive the second multi-bar arrangement by means of the drive motor for the first multi-bar arrangement, a preferred embodiment of the convertible top according to the invention comprises a coupling link between the first multi-bar arrangement and the second multi-bar arrangement. For example, the coupling link is articulated at an articulation point between two links of the first multi-bar arrangement and its end facing away from this articulation point is articulated to a further link of the second multi-bar arrangement.

In order to be able to realize a pivoting movement of the first roof shell relative to the second roof shell when adjusting the convertible top linkage, the second multi-bar arrangement is a seven-bar linkage in a preferred embodiment of the convertible top according to the invention, one link of the seven-bar linkage being another bearing link, i.e., a support link, to which the first roof shell is connected.

A link of the seven-bar linkage is preferably formed by a main link of the first multi-bar arrangement, which is pivotably mounted on the main bearing. In turn, two base links of the seven-bar linkage can be articulated to this main bearing, one of these two base links being articulated to the bearing link and the other being articulated to the bearing link via a further intermediate link. A coupling link can be disposed between the two base links and also has a supporting function.

In order to be able to adjust the height of the main bearing and thus also the link arrangements when adjusting the convertible top between the convertible top position and the storage position, the two main bearings are each displaceable on a guide rail in a special embodiment of the convertible top according to the invention. The height adjustment is carried out in particular by means of at least one other drive motor, which is integrated into the body in a manner fixed to the body.

Further advantages and advantageous embodiments of the subject matter of the invention can be derived from the description, the drawing and the claims. The invention relates to all combinations comprising at least two features disclosed in the description, the claims and/or the figures; i.e., each feature mentioned in the description can in itself be part of the claimed subject matter independently of the further features and/or specifications mentioned in the respective context.

### BRIEF DESCRIPTION OF DRAWINGS

An exemplary embodiment of a convertible top according to the invention is illustrated in a schematically simplified manner in the drawing and is described in more detail hereinafter.

FIG. 1 shows a schematic partial side view of a convertible vehicle having a convertible top according to the invention in its convertible top position.

FIG. 2 shows a view of the convertible top corresponding to FIG. 1, but in an intermediate positon during the displacement to a storage position.

FIG. 3 also shows a view of the convertible top corresponding to FIG. 1, but in another intermediate positon during the displacement to the storage position.

FIG. 4 shows a view of the convertible top corresponding to FIG. 1, but in another intermediate positon during the displacement to the storage position.

FIG. 5 shows a side view of the convertible top in a storage position.

FIG. 6 shows an inner view of the top in its convertible top position.

FIG. 7 shows an inner view of the convertible top corresponding to FIG. 6, but in an intermediate positon during the displacement to the storage position.

FIG. 8 shows an inner view of the convertible top of the storage position, but in an unsecured state.

FIG. 9 shows an inner view of the convertible top corresponding to FIG. 8, but in a secured state.

FIGS. 10a and b show side views of a convertible top linkage of the convertible top in the convertible top position from the outside and from the inside.

FIGS. 11a and b show side views of the convertible top linkage corresponding to FIGS. 10a and b, but in a first intermediate positon during the displacement to the storage position.

FIGS. 12a and b show side views of the convertible top linkage corresponding to FIGS. 10a and b, but in a second intermediate positon during the displacement to the storage position.

FIGS. 13a and b show side views of the convertible top linkage corresponding to FIGS. 10a and b before being lowered to the storage position.

FIG. 14 shows a perspective rear view of the convertible top linkage in the convertible top position.

FIG. 15 shows a top view of the convertible top linkage in the convertible top position.

FIG. 16 shows a partly transparent view of the convertible top linkage in its convertible top position.

FIG. 17 shows a view of the convertible top linkage corresponding to FIG. 16, but in a first intermediate positon during the displacement to the storage position.

FIG. 18 shows a view of the convertible top linkage corresponding to FIG. 16, but in an unsecured storage position.

FIG. 19 also shows a view of the convertible top linkage corresponding to FIG. 16, but in the secured storage position.

FIG. 20 shows a rear view of a lifting mechanism of the convertible top linkage in the convertible top position.

FIG. 21 shows a view of the lifting mechanism corresponding to FIG. 20 in a first intermediate position when lowering the top.

FIG. 22 shows a view of the lifting mechanism corresponding to FIG. 20, but in a second intermediate position when lowering the top.

FIG. 23 also shows a view of the lifting mechanism corresponding to FIG. 20, but in the lowered storage position of the top.

### DETAILED DESCRIPTION

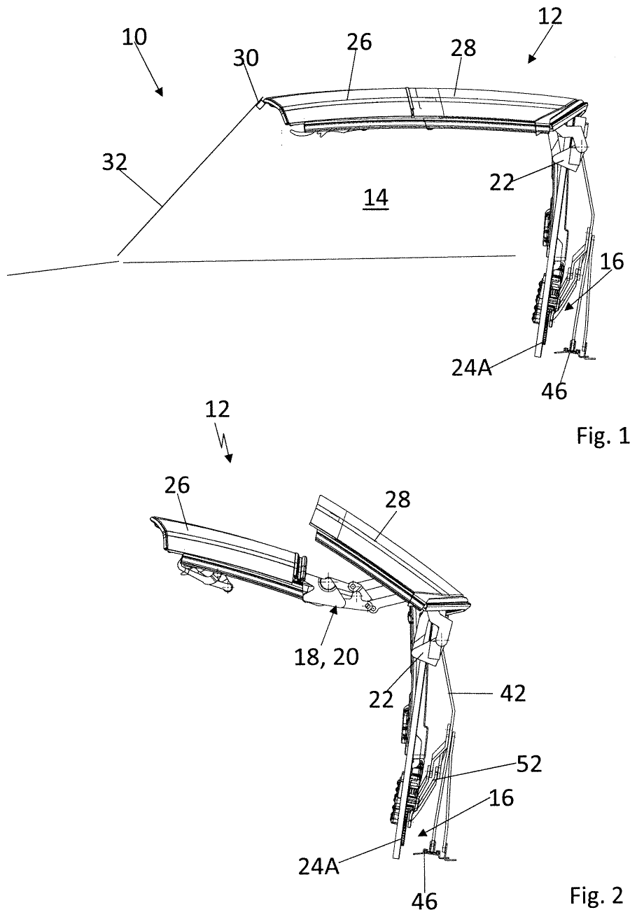

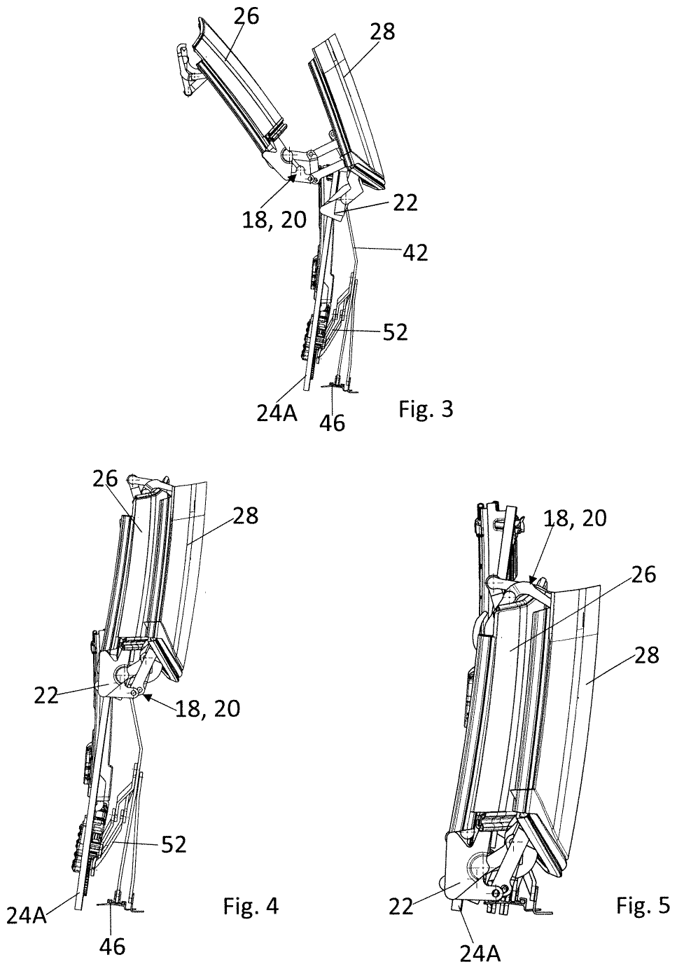

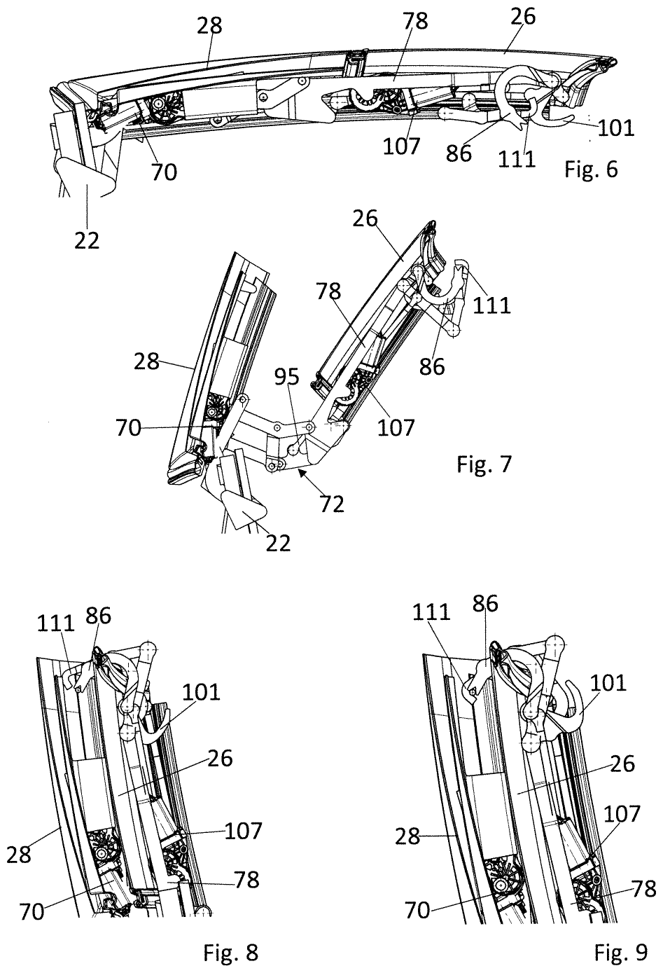

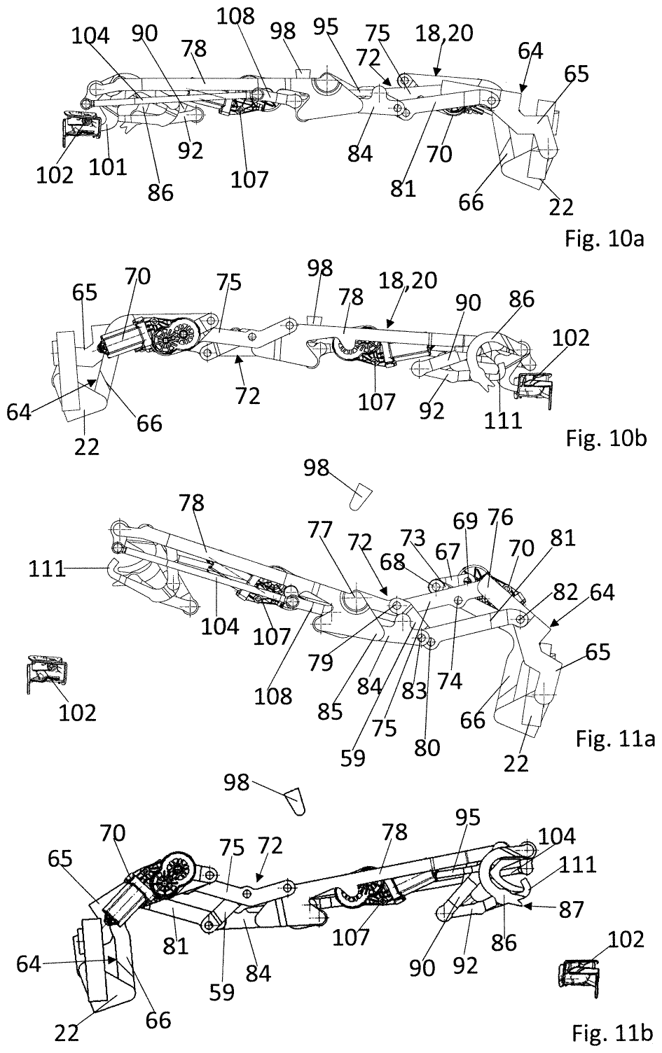

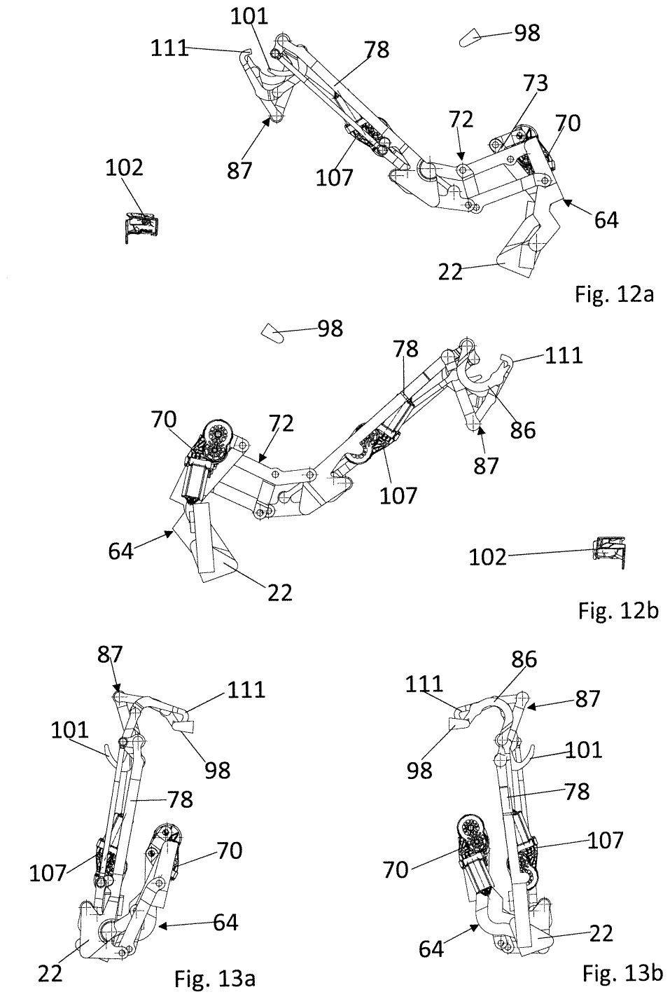

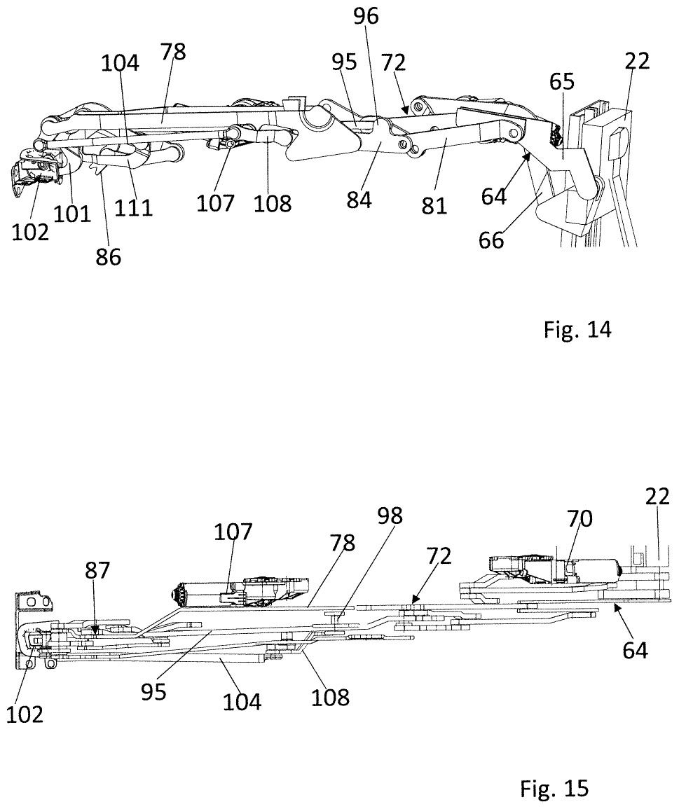

The drawing shows a convertible vehicle 10, which is provided with a displaceable convertible top 12, which is displaceable between a convertible top position (shown in FIG. 1), i.e., a closed position, in which it spans a vehicle interior 14, and a storage position (shown in FIG. 5, for example), i.e., an open position, in which it is disposed in a top storage area 16 disposed to the rear of vehicle interior 14. The convertible top 12 comprises a convertible top linkage 18, which comprises a link arrangement 20 on both of two sides in relation to a vertical longitudinal center convertible-top plane, the link arrangements 20 each being pivotably mounted on a respective main bearing 22. Each main bearing 22 is displaceable in the vertical direction of the vehicle on a respective guide rail 24A or 24B fixed to the body of the vehicle.

The convertible top 12 is designed as a so-called RHT (Retractable Hard Top) and comprises two rigid roof shells 26 and 28, which have outer sides which are disposed flush behind one another in the convertible top position when viewed in the longitudinal direction of the vehicle and are disposed in an upright position in the top storage area 16 in the storage position in such a manner that the front roof shell 26 is disposed in front of the rear-side roof shell 28 in the front direction of the vehicle. The edges of the roof shells 26 and 28 pointing in the direction of the vehicle front in the convertible top position therefore point upwards. The rear roof shell 28 overlaps the outer side of the front roof shell 26 from behind (see FIG. 5). In the convertible top position, the front roof shell 26 is fixed to a front header 30 of the convertible vehicle 10, which forms an upper transverse leg of a frame of a windshield 32.

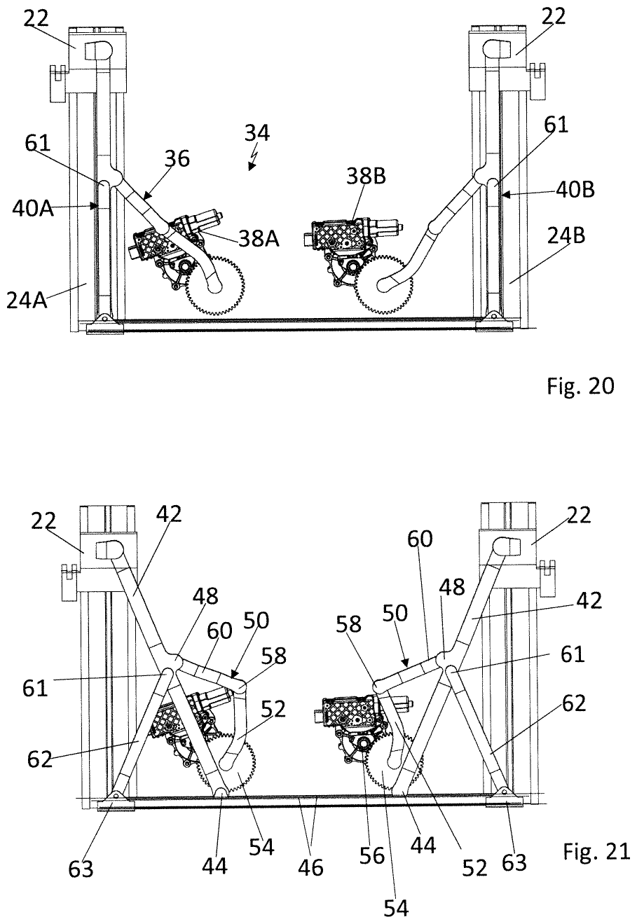

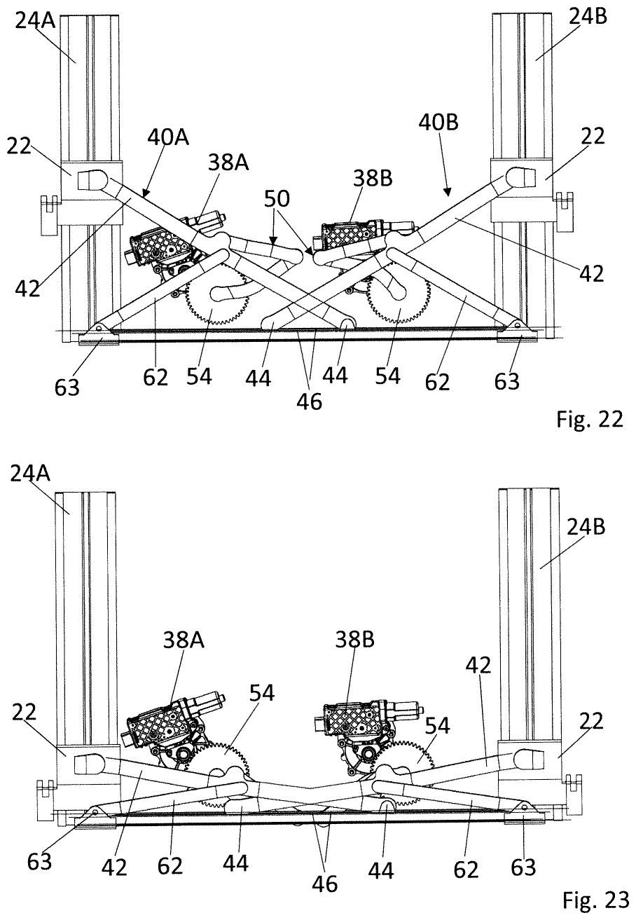

In order to be able to adjust the main bearing 22 on the guide rails 24A and 24B, the convertible top 12 has a drive arrangement 34 which is designed as a lifting mechanism and comprises a lever arrangement 36, which is articulated to the two main bearings 22 and is driven by two drive motors 38A and 38B (see FIGS. 20 to 23).

For each of the two main bearings 22, the lever arrangement 36 comprises a lever unit 40A or 40B, respectively, which can be driven by the respective drive motor 38A or 38B, respectively. The drive motors 38A and 38B are driven synchronously so that the lever units 40A and 40B can be adjusted synchronously. For example, synchronization can be achieved by meshing the gears of the two lever units 40A and 40B (not shown). It is also conceivable that the two lever units 40A and 40B are driven by a shared drive motor.

The two lever units 40A and 40B each comprise a plurality of links which are pivotable in the transverse direction of the vehicle and/or the transverse convertible-top direction. In particular, the lever units 40A and 40B each comprise a main link 42, whose one end is articulated to the respective main bearing 22 and whose other end is pivotably connected to a slider 44, which is displaceably guided in a respective guide track 46 disposed in a fixed manner in the bodywork and extending in the transverse convertible-top direction. A drive link arrangement 50 is articulated to the main link 42 at a respective hinge point 48 and comprises a drive lever 52 which is non-rotatably connected to a toothed wheel 54 which is drivable by a drive pinion 56 of the respective drive motor 38A and/or 38B. At the end facing away from the respective toothed wheel 54, the drive levers 52 are each connected to a link 60 of the drive link arrangement 50 via a hinge point 58, the link 60 being articulated to the respective main link 42 at the hinge point 48.

At a further hinge point 61, a support link 62 is articulated to the main link 42 and in turn is articulated to a respective bearing block 63, which is fixed to the bodywork and/or stationary relative to the guide rails 24A and 24B. In the lifted position of the main bearings 22 shown in FIG. 20, the drive link arrangements 50 each assume an over dead center position, so that the lifted position of the main bearing 22 is secured.

When the drive motors 38A and 38B, which are designed as electric motors, are actuated from the lifted position shown in FIG. 20, an adjusting torque is exerted on the main bearings 22 via the drive link arrangement 50 and the main link 42 so that these can be displaced on the guide rails 24A and 24B and transferred to a lowered position shown in FIG. 23.

Alternatively, it is also conceivable that the drive link arrangements 50 are each articulated to the relevant support link 62. Furthermore, it is also conceivable that the drive link arrangements 50 comprise not only two, but also three or more links.

The link arrangements 20 of the convertible top linkage 18 disposed on both sides of the vertical longitudinal convertible-top center plane are at least largely mirror-symmetrical to one another, for which reason reference is made below essentially only to the link arrangement 20 disposed on the left in relation to the forward direction of travel of the convertible vehicle 10. The link arrangement disposed on the right in relation to the forward direction of travel of the convertible vehicle 10 is designed in a similar manner.

Starting from the height-adjustable main bearing 22, the link arrangements 20 each comprise a four-bar linkage 64, which forms a first multi-bar linkage and which comprises two main links 65 and 66, which are pivotably mounted on the respective main bearing 22. In addition, the four-bar linkage 64 comprises a coupling link 67 which is in the form of a drive link and which is articulated to the main link 66 at a hinge point 68 and is connected to a drive pinion of a drive motor 70 at a pivot point 69, the drive motor 70 being in the form of an electric motor and being rigidly fastened to the main link 65 constituting a bearing link. The drive motor 70 is to be regarded as a component of the four-bar linkage. The rear roof shell 28 is fastened to the main link 65.

The four-bar linkage 64 is coupled to a seven-bar linkage 72, which represents a second multi-bar linkage, via a coupling link 73, which is connected to the four-bar linkage 64 at the hinge point 68 on the one hand and is connected to a base link 75 of the seven-bar linkage 72 at a hinge point 74 on the other hand. To form the seven-bar linkage 72, the base link 75 is articulated to the main link 65 of the four-bar linkage 64 at one end at a hinge point 76 and to a double-shell bearing link 78 at a second end in a hinge point 77, the bearing link 78 being disposed on the bow side in the convertible top position of the top 12 and on which the front roof shell 26 is mounted. The base link 75 is slightly angled and has a hinge point 79 at its bend point, a coupling link 59 being articulated at the hinge point 79 and being articulated to a further base link 81 of the seven-bar linkage 72 at a hinge point 80, the base link 81 being articulated to the main link 65 of the four-bar linkage 64 at a hinge point 82. At its end facing away from the main link 65, the base link 81 has a further hinge point 83, via which it is connected to an intermediate link 84, which is connected to the bearing link 78 at a hinge point 85. The two base links 75 and 81, the main link 65, the coupling link 59, the intermediate link 84 and the bearing link 78 thus form the seven-bar linkage 72 via the described hinge points 76, 77, 79, 80, 82, 83 and 85.

By means of the four-bar linkage 64 and the seven-bar linkage 72, it is possible to pivot the rear roof shell 28 to the upright position from the closed position shown in FIG. 1 by actuating the drive motor 70, and to move the front roof shell 26, which is mounted on the bearing links 78, to the upright position as well, in which it is disposed directly in front of the rear roof shell 28 (see FIGS. 4 and 5).

Furthermore, the two link arrangements 20 are each provided with a stop link 86, which is a component of a stop link arrangement 87. The stop link arrangement 87 forms a four-bar linkage with the bearing link 78 and comprises, in addition to the stop link 86, which is pivotably mounted on the bearing link 78 at a hinge point 88, a link 90 mounted on the bearing link 78 at a hinge point 89 and connected to a coupler 92 via a hinge point 91 at its end facing away from the hinge point 89, the coupler 92 being articulated to the stop link 86 at a hinge point 93. The stop link 86 has a fork-like stop surface 97 on the end face, the stop surface 97 representing the effective surface of the stop link 86.

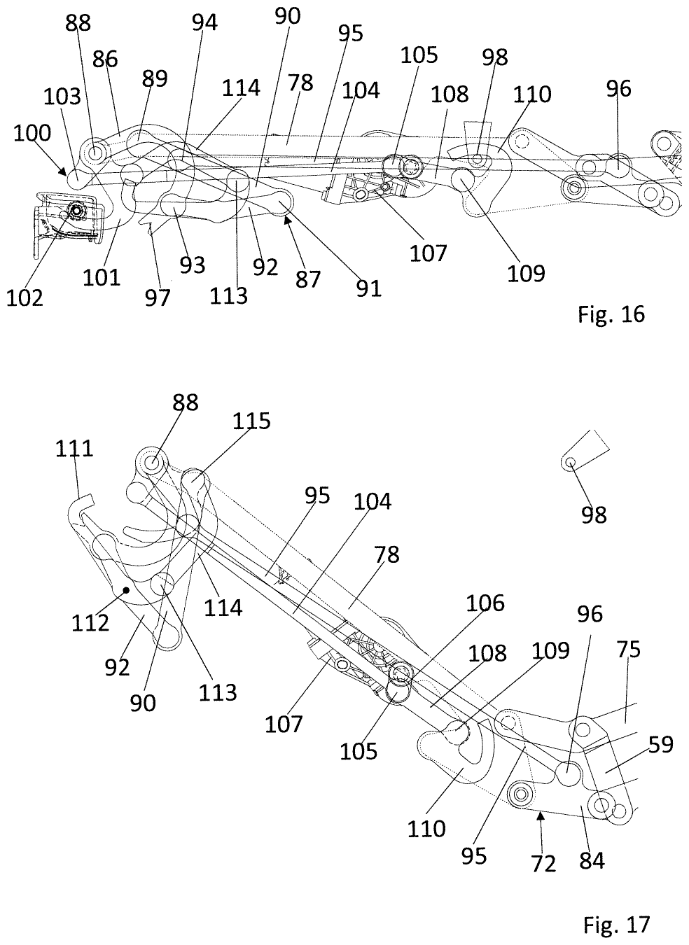

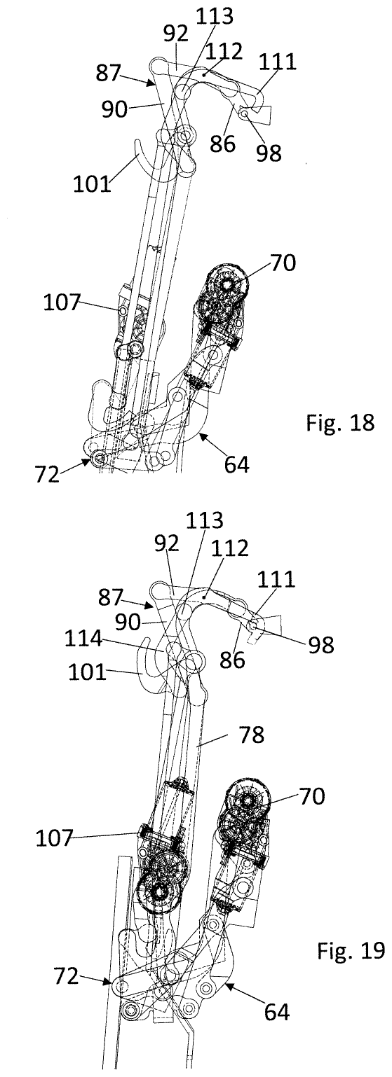

For actuation, the link 90 of the stop link arrangement 87 is connected to a drive rod 95 at a hinge point 94, end of the drive rod 95 facing away from the stop link arrangement 87 being connected to the intermediate link 84 of the seven-bar linkage 72 at a hinge point 96. Via the drive rod 95, the stop link 86 can be pivoted from its rest position shown in FIG. 16 to the active position shown in FIGS. 18 and 19, where it engages over a front edge of the front roof shell 26 and the stop surface 97 rests against a counter stop element 98, which is disposed on the underside of the rear roof shell 28 and is designed in the manner of a roll. The relative position between the two roof shells 26 and 28 in the storage position of the convertible top 12 is defined by the stop links 86 which are disposed on both sides and rest against the counter stop elements 98 disposed on both sides via their stop surfaces 97.

To secure the convertible top 12 in the convertible top position, a closing unit 100 is provided at each of the link arrangements 20 disposed on either of two sides, the closing unit 100 comprising a front locking hook 101 whose pivot axis coincides with the pivot axis of the stop link 86, i.e., which can also be pivoted about the pivot axis defined by the hinge point 88 and, in its locking position shown in FIG. 16, is engaged with a locking element 102 disposed on the front header 30. For the drive, the locking hook 101 is connected to a lock rod 104 via a hinge point 103, and end of the lock rod facing away from the locking hook 101 being articulated to a drive lever 106 via a hinge point 105, the drive lever 106 being driven by a front closing drive 107 designed as an electric motor. A further closing rod 108 is articulated to the drive lever 106 via the hinge point 105 and is connected to a closing hook 110 via a hinge point 109, the closing hook 110, when in the convertible top position of the convertible top 12, being engaged with the counter stop element 98, which forms a flying stop and is disposed on the underside of the rear roof shell 28. This secures the two roof shells 26 and 28 to each other in the convertible top position.

In order to secure the two roof shells 26 and 28 to each other in the storage position, the link arrangements 20 disposed on either of two sides also have a stop lock 111, which is pivotably mounted on the coupling 92 of the stop link arrangement 87 at a hinge point 112 and is connected to a coupling link 114 via a hinge point 113, the coupling link 114 being articulated to the locking hook 101 at a hinge point 115. By actuating the front closing drive 107, it is therefore possible to pivot the stop lock 111 between a release position (see FIG. 18) and a locking position (see FIG. 19) via the lock rod 104, the locking hook 101 and the coupling link 114, where it engages with the counter stop element 98 and thus holds the front roof shell 26 on the rear roof shell 28. This provides an intermediate shell locking mechanism in which support is provided between the various elements within the kinematics. The support is provided on the side of the roof shell 28 on which the movement is initiated when the drive motor 70 is actuated. In the storage position, the two roof shells 26 and 28 are equally curved behind each other. When the roof shells 26 and 28 are moved to the convertible top position, the stop links 86 are pivoted from the active position to the rest position located below the roof shell 26. In the active position, however, the stop links 86 provide stable support between the roof shells 26 and 28. The stop locks 111, which are designed like hooks, allow the roof shells 26 and 28 to be actively locked together in the storage position. The locking mechanism not only prevents the attached roof shell 28 from moving against the displaceable stop link 86, but also prevents the roof shell 28 from moving in the opposite direction. This completely fixes the relative movement of the roof shells 26 and 28 to each other.

### Reference Signs

10 convertible vehicle

12 convertible top

14 vehicle interior

16 top storage area

18 convertible top linkage

20 link arrangement

22 main bearing

24A, B guide rail

26 roof shell

28 roof shell

30 front windshield header

32 windshield

34 drive arrangement

36 lever arrangement

38A, B drive motor

40A, B lever unit

42 main link

44 slider

46 guide track

48 hinge point

50 drive link arrangement

52 drive lever

54 toothed wheel

56 drive pinion

58 hinge point

59 coupling link

60 link

61 hinge point

62 support link

63 bearing block

64 four-bar linkage

65 main link

66 main link

67 coupling link

68 hinge point

69 pivot point

70 drive motor

72 seven-bar linkage

73 coupling link

74 hinge point

75 base link

76 hinge point

77 hinge point

78 bearing link

79 hinge point

80 hinge point

81 base link

82 hinge point

83 hinge point

84 intermediate link

85 hinge point

86 stop link

87 stop link arrangement

88 hinge point

89 hinge point

90 link

91 hinge point

92 coupler

93 hinge point

94 hinge point

95 drive rod

96 hinge point

97 stop surface

98 counter stop element

100 closing unit

101 locking hook

102 locking element

103 hinge point

104 lock rod

105 hinge point

106 drive lever

107 front closing drive

108 closing rod

109 hinge point

110 closing hook

111 stop lock

112 hinge point

113 hinge point

114 coupling link

115 hinge point

1. A convertible top, comprising:
a first curved roof shell,
a second curved roof shell and
a convertible top linkage, by which the two roof shells are displaceable between a cover position, which spans a vehicle interior and in which the two roof shells are disposed one behind the other in the longitudinal roof direction, and a storage position, which opens the vehicle interior towards the top and in which the two roof shells are received by a convertible top storage space and are disposed one behind the other in an upright position in the same curve direction,
the convertible top linkage comprising a link arrangement on each of two sides in relation to a vertical longitudinal center convertible-top plane,
the link arrangements each comprising a first multi-bar arrangement, a second multi-bar arrangement, which is driven by the first multi-bar arrangement, and a main bearing, on which the first multi-bar arrangement is articulated and which is adjustable in height.

2. The convertible top according to claim 1, wherein the first multi-bar arrangement is a four-bar arrangement and a link of the four-bar arrangement is a bearing link, to which the second roof shell is connected and which is a main link, which is pivotably mounted on the main bearing.

3. The convertible top according to claim 2, wherein a drive motor is fastened to the bearing link for the four-bar arrangement.

4. The convertible top according to claim 1, wherein the first multi-bar arrangement drives the second multi-bar arrangement via a coupling link.

5. The convertible top according to claim 1, wherein the second multi-bar arrangement is a seven-bar arrangement and a link of the seven-bar arrangement is a bearing link, to which the first roof shell is connected.

6. The convertible top according to claim 5, wherein a link of the seven-bar link is formed by a main link of the first multi-bar arrangement, which is pivotably mounted on the main bearing.

7. The convertible top according to claim 1, wherein the main bearing is displaceable on a guide rail to be adjustable in height.
